(19) United States
(12) Patent Application Publication
(10) Pub. No.: US 2011/0258925 A1
(43) Pub. Date: Oct. 27, 2011

(54) Vertical planter

(76) Inventor: Richard L. Baker, Versailles, KY (US)

(21) Appl. No.: 13/066,600

(22) Filed: Apr. 19, 2011

Related U.S. Application Data
(60) Provisional application No. 61/343,201, filed on Apr. 26, 2010.
(60) Provisional application No. 61/465,597, filed on Mar. 14, 2011.

(51) Int. Cl. A01G 9/02

(52) U.S. Cl. 47/65.8; 47/66.1

(57) ABSTRACT

A vertical planter includes stackable planter units each with plural sections in which plural plants can be planted. Each section of a planter unit can have a removable faceplate for placing soil in the planter section and planting plants in the soil, or potted plants can be placed in the faceplate openings. Water is provided to each planter section via a drip irrigation tube fed from a main water supply tube that extends to each planter unit. The drain water from each planter unit drains down through an underlying planter unit and into an underlying water reservoir.

### CROSS REFERENCE TO RELATED APPLICATIONS

This non-provisional patent application claims the benefit of pending U.S. provisional patent applications a) Ser. No. 61/343,201 filed Apr. 19, 2010, entitled “Vertical Garden Modular Plant Core,” and b) Ser. No. 61/(not yet received) , filed Mar. 11, 2011, named inventor—Richard L. Baker, and entitled “Self-Contained Vertical Garden.”

### TECHNICAL FIELD OF THE INVENTION

The present invention generally relates to planters for greenery, and in particular to vertical planters where one set of plants is oriented generally above another set of plants.

### BACKGROUND OF THE INVENTION

Green walls are becoming popular because of the pleasant appearance and the feeling of purity of the environment. A green wall is a wall, either free-standing or part of a building, that is partially or completely covered with vegetation and, in some cases, soil or an inorganic growing medium. The vegetation for a green facade is generally attached on outside walls. With living walls this is also usually the case, although some living walls can also be green walls for interior use. Living walls can be attached to air return ducts of a building to help with air filtration. These are also referred to as living walls, biowalls, or vertical gardens.

The practice of gardening is the most popular leisure time activity in all the industrialized nations. It is enjoyed by people of all ages. In the age of going green, vertical gardening offers a method to bring a significant number of plants to an interior or exterior surface and to keep them healthy, while creating an environment that relieves stress and that oxygenates the surrounding areas in which the greenery is placed.

Builders and real estate owners are concerned with LEED points. Techniques for incorporating plants into a building plan can get LEED points for sustainability. Homeowners are often desirous of beautifying interior spaces.

Many types of planters exist and some are designed to alleviate limited space requirements or to provide a way to grow plants when open space and soil is not available. Some planters arrange pants in towers or other vertical arrangements. See for example U.S. Pat. No. 5,363,594. U.S. Pat. No. 3,841,023 discloses a display apparatus for potted plants that includes a vertical stack of trays spaced one above the other, and allows the water to flow through an overflow drain.

Other patents relating to planters include U.S. Pat. Nos. 3,841,023, 5,031,359 and 2,070,403. A relevant patent is the European patent of Patrick Blanc, (EP 1 759 578 A1) which utilizes two layers of cloth mounted on a common frame attached to a vertical surface. Cloth pockets are adapted for holding plants. In the Blanc method, the plant roots take hold in a “rooting fabric” and nutrients flow through the fabric using a pump and irrigation tubing mounted laterally across the growing surface at various intervals. This method does not fare well over time. The fabric becomes coated with moss and sediment and upon close inspection is unsightly. The felt material often tears and shows extreme wear over only a few years in the environment.

There are two main categories of green walls: green facades and living walls. Green facades are made up of climbing plants either growing directly on a wall or, more recently, specially designed supporting frameworks. The plant shoot system grows up the side of the building while being rooted in the ground. With a living wall, the modular panels are often made of stainless steel or plastic containers, geotextiles and incorporate irrigation systems, a growing medium and vegetation.

There are three types of growth media used in living walls, namely, loose media, mat media and structural media. Loose medium walls tend to be “soil-on-a-shelf” or “soil-in-a-bag”. Loose medium systems pack the soil into a shelf or bag and then are installed onto the wall. These systems require the media to be replaced at least once a year on exteriors and approximately every two years on interiors. Repairs are only achieved by re-stuffing soil into the holes on the wall, which is both difficult and messy. Loose-soil systems should not be used in areas where there will be a lot of public interaction as they are quite messy and lose their soil little by little over time as their medium wets and dries, falling out onto the floor in front, if not properly designed. Most importantly, because these systems can easily have their medium blown away by wind-driven rain or heavy winds, they should not be used in applications over eight feet high. Loose-soil systems are best suited for the home gardener where occasional replanting is desired from season to season or year to year.

Mat type systems tend to be either coir fibre or felt mats. Mat media are quite thin, even in multiple layers, and as such cannot support vibrant root systems of mature plants for more than three to five years before the roots overtake the mat and water is not able to adequately wick through the mats. The method of reparation of these systems is to replace large sections of the system at a time which compromises the root structures of the neighboring plants on the wall. It is important to note that mat systems are particularly water inefficient and often require constant irrigation due to the thin nature of the medium and its inability to hold water and provide a buffer for the plant roots. This inefficiency requires that these systems have a water re-circulation system put into place at an additional cost. Mat media systems are better suited for small installations no more than eight feet in height where repairs are easily completed.

Structural media are growth medium “blocks” that are not loose, nor mats, but incorporate the best features of both into a block that can be manufactured into various sizes, shapes and thicknesses. The block media has the advantage that it does not break down for ten to fifteen years, can be made to have a higher or lower water holding capacity depending on the plant selection for the wall, can have the pH and EC's customized to suit the plants, and are easily handled for maintenance and replacements. The downside is that these systems are often very expensive to install.

A need exists for a modular system for growing a multitude of plants on vertical surfaces. The system has plant receptacles in the front and mounting points on the back and sides. More important, it can be expanded to accommodate small or very large vertical garden walls, and it is fashioned in such a way that the system keeps all water contained within the structure.

Another need exists for a planer that can use any type of soil media, that maximizes water use, provides a long term environment for optimum plant health and is very easy and inexpensive to install and maintain. A further need exists for a planter that also has the benefit of ultimate flexibility with easy plant removal and replacement.

An additional need exists for a modular system, with multiple ways to run irrigation tubing, that is watertight, that recycles the water and nutrients, thereby optimizing water use while creating the perfect growing environment for a very diverse array of plants.

An important need exists for a planter system that is simple to install by a homeowner with a battery operated drill and mounting screws, but it also works in a commercial environment allowing contractors to create large scale walls in public spaces. An ancillary need exists for a method of planter mounting and water control to the planter system so as to lower the installation cost, as compared to most other methods available to create vertical green walls.

It can be seen from the foregoing that a need exists for a vertical planter that is constructed as units that are stackable together to form an arrangement of tiered plants. A further need exists for a planter unit that presents the plants so that the tops and sides are seen. Another need exists for a vertical planter having a watering system that allows the plants to be watered internally in the planter and drained downwardly into a water basin or reservoir. A need exists for a vertical planter where the planter units are stackable to a desired height, but yet allow watering of all of the plants without over-watering the plants in the lower planter units.

### SUMMARY OF THE INVENTION

In accordance with the principles and concepts of the invention, disclosed is a vertical planter that includes stackable planter units, where each planter unit accommodates plural plants, and where the plants can be watered internally in the planter units.

According to feature of the invention, the vertical planter is situated over a water reservoir so that the water can be pumped up into the planter units to water the plants, and the excess water migrated downwardly to drain in the water reservoir. The dripping of the water into the reservoir from the overlying planter unit provides a pleasing sound.

According to yet another feature of the invention, the individual planter units can be removably supported to a wall so that the lower planter units do not have to support the weight of the overlying planter units. An array of planter units can be fastened to the wall and when populated with mature plants, the entire wall appears covered with vegetation.

According to a further embodiment of the invention, a vertical planter is self-contained and self supporting on a surface. According to this embodiment, the vertical planter is unitary in construction so that the planter sections of a unit are made integral with an underlying water reservoir. A pump in the water reservoir pumps water through a tubing system to water heads or nozzles located somewhat above the plant locations. The plants are thus watered, whereupon the excess water drains down from each plant section into the water reservoir to be recirculated during the watering cycle.

According to one embodiment, disclosed is a vertical planter for growing vegetation. The vertical planter includes a planter unit comprising plural plant sections where each plant section has plural locations, and each location is for growing a plant. The plant sections are arranged in a vertical manner to form a unitary said planter unit. Each plant section has a faceplate with openings therein for holding a plant, and each faceplate is angled to hold the plants at an angle. Each plant section of the unitary planter unit has an interior in common with other plant sections of the planter unit so that water that drains from the plants flows through the underlying plant sections to a bottom of the planter unit. A water reservoir underlies a lower-most plant section so that water drains from the planter unit into the reservoir.

According to another embodiment, disclosed is a vertical planter for growing vegetation, where the vertical planter includes a base comprising a water reservoir for resting on a flat surface, and the base has an opening therein for pouring water into the reservoir. Plural plant sections are formed as a unitary unit together with the water reservoir. The plant sections have a frontal surface that is stair step shaped, and the parallel first surfaces of the stair step frontal surface have openings therein for holding potted plants therein. Parallel second surfaces of the stair step frontal surface have water heads mounted therein, where each water head is located over a respective plant opening. A top of the unitary unit includes an opening through which water can be poured, and a lid covers the top opening of the unitary unit. The lid is removable from the top opening. A water tubing system is mounted inside said unitary unit and is connected to each of the water heads. A pump is connected to the water tubing system, and the pump is located in the water reservoir for pumping water through the water tubing system, through the water heads and onto plants located in the plant sections.

### BRIEF DESCRIPTION OF THE DRAWINGS

Further features and advantages will become apparent from the following and more particular description of the preferred and other embodiments of the invention, as illustrated in the accompanying drawings in which like reference characters generally refer to the same parts, functions or elements throughout the views, and in which:

FIG. 1 is an isometric view of a vertical planter according to one embodiment;

FIG. 2 is an isometric view of a mesh bag adapted for holding a plant and insertion into an opening of a planter unit;

FIG. 3 is an exploded view of the of apportion of a planter unit with one faceplate removed from the respective planter section;

FIG. 4 is a side view of a portion of the vertical planter of FIG. 1, showing the stacking of the planter units, and attachment to a vertical wall;

FIG. 5 is an isometric bottom view of another embodiment of a planter unit showing the drainage slots therein;

FIG. 6 is an isometric view of an embodiment of a self-contained vertical planter;

FIG. 7 is a cross-sectional view of the vertical planter of FIG. 6;

FIG. 8 is a frontal view of a vertical planter according to another embodiment;

FIG. 9 is an isometric side view of the vertical planter of FIG. 8

FIG. 10 is a frontal view of a planter unit;

FIG. 11 is a side view of the planter unit of FIG. 10;

FIG. 12 is an isometric top view of a planter unit showing the drain inlets;

FIG. 13 is a bottom view of the planter unit of FIG. 10, showing the drain outlets;

FIG. 14 is an isometric view of a water basin used with one or more overlying planter units;

FIG. 15 is a side view of the water basin of FIG. 14; and

FIG. 16 is a frontal view of an array of stacked planter units and the irrigation system.

### DETAILED DESCRIPTION OF THE INVENTION

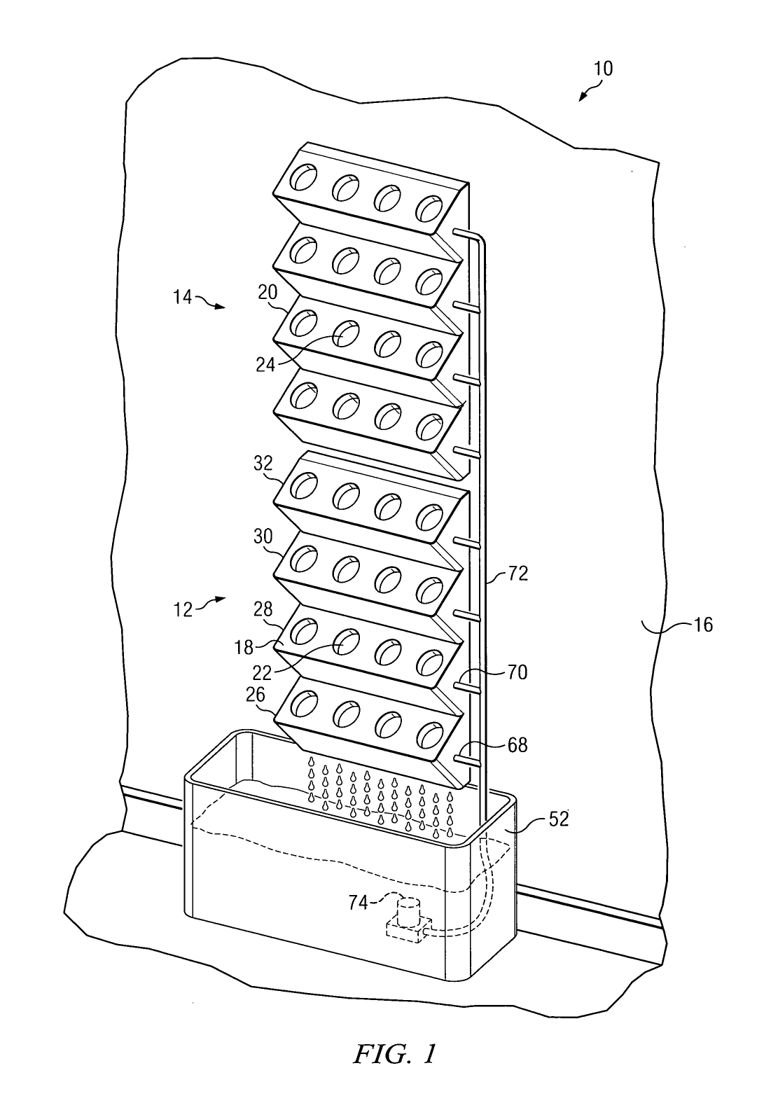

According to one embodiment of the invention, FIG. 1 illustrates a vertical planter 10 that is modular in construction so that different units can be arranged together to form a single vertical planter to accommodate a desired number of plants. The vertical planter 10 includes a first planter unit 12 and a second planter unit 14 that is mounted on top of the first planter unit 12. The vertical planter 10 is fastened to a wall 16 which can be of any type of structure, including the studs to which sheet rock is nailed, a mason or brick wall, or any other type of interior or outside vertical wall. Moreover, the vertical planter can be mounted to a wall of a building, or a free standing wall, fence or any other type of vertical support.

The planter units, such as unit 12, can be constructed from a variety of structurally strong, water tight materials, such as plastic. Since each unit of the vertical planter 10 is constructed in an identical or similar manner, only the bottom planter unit 12 will be described below. The plastic can be of the type that can be and molded to form individual components. The components can be bonded together or otherwise fastened together to form a planter unit 12, or molded to form the entire planter unit 12 as a unitary part. For example, the front, sides, top and bottom of each planter unit 12 can be molded as a body, and the back can be molded separately and then bonded to the body component to make the overall unit waterproof and sufficiently rigid to hold dirt and plants therein without cracking or flexing. Each planter unit 12 includes at least one faceplate, such as faceplate 18 for planter unit 12 and faceplate 20 for planter unit 14.

In the embodiment illustrated in FIG. 1, planter unit 12 is constructed to include four faceplates, and planter unit 14 is also constructed to included four faceplates. Each faceplate, for example faceplate 18 of planter unit 12, is constructed with four openings to hold four plants. One opening in faceplate 18 is identified with numeral 22, and one opening in faceplate 20 of planter unit 14 is identified as numeral 24. Rather than being molded integral with the planter unit 12, the faceplates 18 can be made removable so that a planter unit 12 can be fitted with different faceplates to receive different size plants therein. In this instance, the removable faceplate can be snap fit, screwed or otherwise fastened to the rectangular opening in the planter unit 12. Corrosion resistant metals or synthetic materials can be used with equal effectiveness. The planter unit 12 can be of various dimensions. In an embodiment, the planter unit 12 can be 32″ wide, 40′ high and 8″ deep. A planter section is a single horizontal location of a planter unit 12 that holds one or more plants. The planter unit 12 of FIG. 1 is constructed with four planter sections 26, 28, 30 and 32, where each planter section has four openings 22 for four different plants. A total of sixteen plant locations are available for planting plants therein. Other numbers of plant locations in a faceplate 12 can be employed.

Each of the faceplates 18 and 20 is angled with respect to the body of the respective planter units 12 and 14, like stair steps that are oriented vertically. However, the depth and height of the planter units 12 and 14 are variable to allow flexibility for installation. The widths should be consistent with stud framing widths commonly used in modern construction, if mounted to building walls. This allows the units 12 and 14 to be easily fastened to wall studs and the like to support the vertical planter 10 to a wall 16.

Each planter unit 12 is hollow so that it can be filled with soil or other plant growing media. The media could be organic or any commercially viable type of potting mix, or simply a media designed to transport water that will allow osmosis. The soil or mix can be inserted into the planter unit 12 through the plant openings 22, or by removing the faceplate 18 and placing the soil in the interior of the unit 12. Plants are placed in the soil exposed by the circular. openings 22 of the unit 12, with the upper part of the plant displayed outside the faceplate 18, while the root portion of the plant is inserted into the soil and resides inside the interior of the planter unit 12 where it receivs water and nutrients.

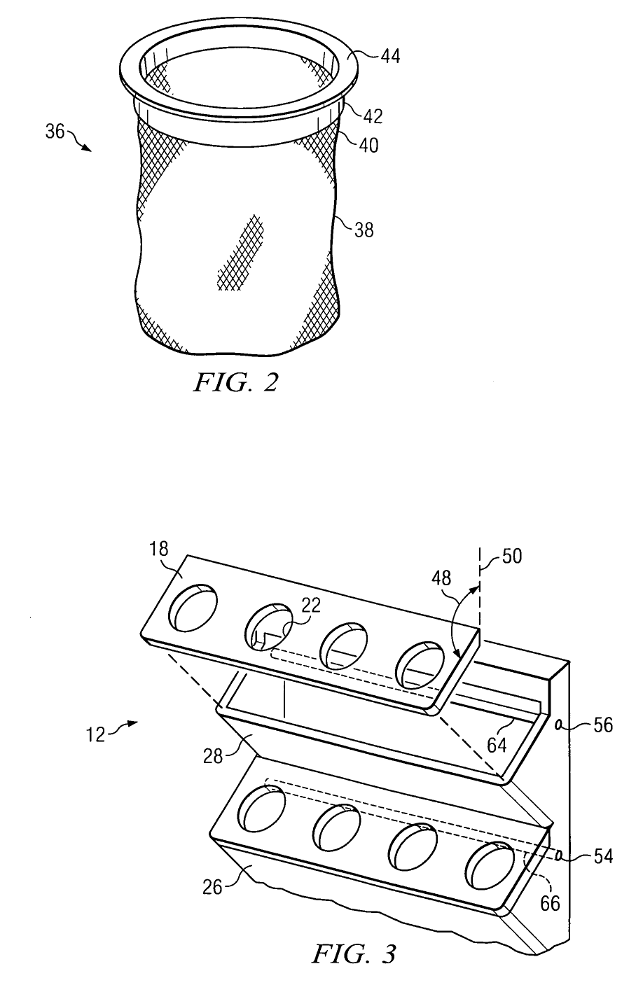

The planter unit 12 can be open and without barriers or internal division. The planter unit 12 can also be effectively compartmentalized by inserting a water permeable bag 36 with a round opening into each opening of a faceplate 18. A mesh bag 36 suitable for use is illustrated in FIG. 2. The planter unit 12 can also be compartmentalized by using water permeable dividers between the plant locations. In the absence of a bag 36 or dividers, plants can be planted directly into the soil of each section 26, 28, 30 and 32, whereby the roots are allowed to expand into the entire interior portion of the planter unit 12.

As noted above, the faceplates 18 of the planter unit 12 can be constructed so as to be removable. The faceplates 18 and 20 can be constructed with openings of different sizes. For example, one set of faceplates can have three-inch diameter openings, and other faceplates can have four-inch diameter openings. The diameter of the openings in the faceplates can be of any size to accommodate the size of commercially available plants or potted plants. This feature of the invention allows the different sections of the planter unit 12 to accommodate potted plants of different sizes, it being realized that a plastic plant pot can be inserted into an opening and supported by the faceplate 18. Similarly, one planter unit, such as a bottom planter unit 12 could be equipped with sections having faceplates with four-inch openings to handle four-inch potted plants. The upper planter unit 14 could be equipped with sections having faceplates with three-inch openings. With this feature, different size potted plants can be used in the same vertical planter. In addition to the foregoing, plural vertical planters 10 can be utilized together to provide an array of potted or planted plants. For example, a first vertical planter 10 can be fastened to a wall adjacent to one or more other vertical planters. Each vertical planter can be equipped with planter units having faceplates of different size openings. One vertical planter can have planter units with faceplates constructed with three-inch openings, an adjacent vertical planter can have planter units with faceplates constructed with four-inch openings, and yet another vertical planter can be equipped with faceplates having six-inch openings. Indeed, by using removable faceplates with the planter units, one can mix and match a number of different faceplates in a single planter unit, or in several planter units. This is useful to accommodate different plants of different sizes to provide an aesthetically pleasing arrangement of plants. For example, some plant locations can be vines, and other plant locations can be flowered plants. Other plants, including vegetables, herbs or grass can be planted at each plant location. With the construction of the planter units, the foliage and flowers of a plant obscure the part of the planter unit therebehind so that only the plants are visible, rather than the surfaces of the planter units. As such, when mature plants are placed in the vertical planters, the appearance is a blanket or wall of flowers, vines, or the like, and the frontal surface of the entire planter structure is totally obscured.

The plant openings 22 in the faceplate 18 of the section 28 can be used as a receptacle and support for conventional plastic plant pots. The diameter of the plant openings 22 is formed so that the annular rim of a plastic pot will prevent the pot from falling through the plant opening 22. This feature allows users to select and arrange plants until they achieve the desired design. If a plant dies, it is easy to remove the old plant and replace it with a new plant. Additionally, if one desires to change the color of the potted flowers periodically, then one needs only to remove the potted plants and replace them with other potted plants having different colored flowers or foliage. This avoids working with replacement of dirt and the messy job of planting the new plants in the dirt. This can be advantageous when the vertical planter 10 is placed in a location frequented by people, such as atriums, reception areas, etc., so that the color and visual appearance can be easily changed at different times, such as monthly. For a two-unit vertical planter 10 such as shown in FIG. 1, the time required to change out all thirty-two potted plants can be as little as fifteen minutes. Moreover, the potted plants removed from the vertical planter 10 can be taken to another vertical planter and placed therein so as to also change the appearance thereof.

As noted above, the plants can be planted in the soil contained in respective bags 36. One bag 36 is shown in FIG. 2. The plant bag 36 is constructed using a mesh-type material 38 to form a bag that contains soil. The mesh material 38 can be a synthetic material that does not break down and deteriorate over time. The mesh material 38 of the bag 36 contains the soil or organic matter, but allows water to pass through the porous openings of the mesh 38. The mesh material 38 can be plastic or fabric or other suitable material and constructed in the shape of a pocket or bag. The rim 48 of the opening of the mesh bag 38 is fastened to a support ring 42 that fits into a plant opening in the faceplate. A flange portion 44 of the support ring 42 is wider than the diameter of the faceplate opening 22 and thus will not pass through the faceplate opening 22. A plastic material or other rigid material can be used to construct the support ring 42 and the flange 44 as an integral member. The annular top portion 40 of the mesh bag 38 can be bonded to the support ring 42 by any suitable means. It can be seen that when the planter bag 36 is employed, it can be easily installed in the planter unit 12, and removed therefrom, much as conventional potted plants. Depending on the particular application, a person can use both potted plants and plant bags in the same planter unit 12.

Rather than utilizing potted plants in the vertical planter 10, the planter units 12 and 14 can be filled with soil or other organic medium, and the plants can be planted directly in the soil through the faceplate openings 22 and 24. When using the direct planting technique, the user can remove the faceplates of a unit 12 and fill each section 26, 28, 30 and 32 with soil or plant growing media. FIG. 3 illustrates one faceplate 18 removed from the section 28. The faceplate 18 can be snap fit or otherwise fastened using screws or other suitable fasteners. When snap fit, the inside surface of the faceplate 18 can be formed with outwardly extending dimples, and the corresponding locations of the plant section can have dimpled recesses for snap fitting the faceplate 18 thereto. Many other snap fit mechanisms can be employed with equal effectiveness. In other instances, the faceplates 18 can be simply friction fit onto the top rectangular opening of the section 28. In any event, each section can be filled with the soil up to the faceplate location. The faceplates 18 can then be placed back on the respective section. Plants can then be planted directly in the soil through the plant openings 22. As will be described more fully below, each section of the planter unit 12 can be separated by the adjacent section with a fine wire mesh to maintain any soil in the respective section, but allow water to drain therehrough to the underlying section.

The flexibility of having different planting options is a useful feature of the vertical planter 10 because some plants may require a substantial amount of soil area to grow and maintain optimum health, as compared to other plants. Without a sufficient volume of soil, some types of plants can become root-bound, resulting in stifled growth or death. Other plants may be more suitable to containers like the plant pots or plant bags. Some sections of a planter unit 12 can accommodate potted plants and other sections of the planter unit 12 can be filled with soil and plants planted therein via the plant openings. This provides a great versatility in the different type of plants that can be used to make an overall arrangement.

FIG. 3 illustrates the angle of the faceplate 18 with respect to a vertical reference. If the faceplate 18 is too horizontal, the plants are oriented upwardly or vertical. In this orientation, less of the plant would be visible to viewers standing in front of the unit 12. Since vertical plant walls are generally viewed from the side, a beneficial effect is achieved by having the faceplate 18 angled so that both the side and the top of the plant are visible. The role of gravity is important. To that end, gravity holds the pots in place in the faceplate 18, so the faceplate angle 48 shouldn't be too vertical. It is contemplated that an optimal range for the faceplate angle 48 is between 140 to 160 degrees, as measured with respect to a vertical axis 50 extending upwardly.

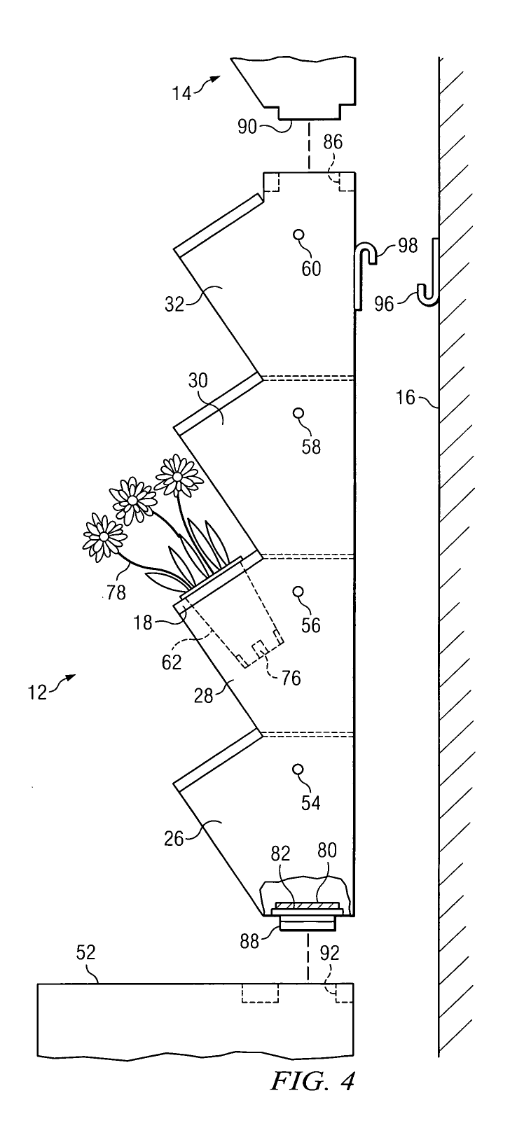

Each unit 12 and 14 is equipped with a side water access hole for each of the four sections. FIG. 4 illustrates a portion of a planter unit 14 stackable on top of planter unit 12, and the bottom unit 12 stackable on top of a water reservoir or basin 52. Vertical planter unit 12 includes water access hole 54 for watering the plants in section 26, and three other water access holes 56, 58 and 60 are associated with sections 28, 30 and 32. Located within each vertical planter section is a horizontal perforated tube for drip irrigation on the bottom of the pots. The horizontal drip irrigation tube is shown as numeral 64 in FIG. 3 for section 28, and as numeral 66 for section 26. An external water supply tube can be connected to the protruding stub of the irrigation drip tubes 64 and 66. The short external water supply tubes 68 and 70 shown in FIG. 1 can be connected to a main supply tube 72. The horizontal drip irrigation tubes 64 and 66 can be connected to a main vertical supply tube 72 internal to the vertical planter units so as not to be visible, and if any leaks form in the connections, the leak will be internal to the planter units and thus generally inconsequential. The main vertical water supply tube 72 can extend down into the water reservoir 52 and be connected to a water pump 74. The water carrying tubes and drip irrigation tubes within the planter sections can be supported by brackets in a customary manner. One water access hole can be located on either side of each planter unit, and one water access hole can be formed in the top center of the rear of the unit. Since gravity allows water to flow downward from the drip irrigation water tubing 64 and 66, the location of these water access holes should be higher than the root system of the plant. When potted plants are used, the bottom of the plastic pot 62 (FIG. 4) includes water drain holes 76 to allow water from the overlying drip irrigation tube 64 to be drawn within the pot 62 via the drain holes 76 and absorbed by the soil and roots of the plant 78. The drip irrigation tubing 64 is inserted across the top of each planter section of the unit and connected to the supply 52 of water. Unused water access holes are plugged with a stopper to prevent leakage. In side-by-side vertical planters, the water connections between the units can be connected together with short flexible tubing and clamps. Water can be supplied upwardly by a main water supply line 72 to one vertical planter, and then across to the adjacent vertical planter. Alternatively, a separate main water supply line can be extended upwardly along the outermost vertical planters, and then laterally across to the intermediate vertical planters.

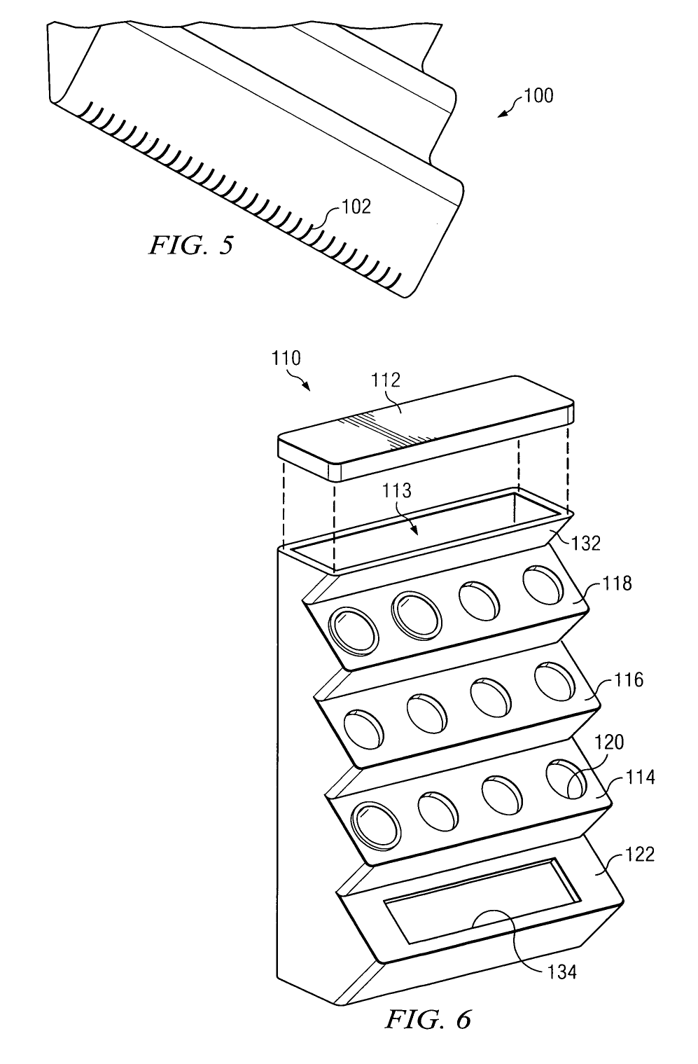

The top and bottom of each planter unit 12 is open, although the top planter unit of the vertical planter 10 can be constructed with a closed top, and with a cover to cover the top rectangular opening of the top planter unit. The bottom of each planter unit 12 has a drain grate 80 to allow water to drain out of the bottom and into either the open top of the underlying planter unit, or into the water reservoir 52. One grate 80 is shown in the cut-away view of FIG. 4 with respect to the bottom of planter section 32. The bottom drain is angled and a grate that spans the bottom of the planter unit. The grates can be formed using expanded metal, or other suitable rigid, porous structures. A filter 82 can overlie each grate 80. The filter 82 and grate 80 prevents soil from falling out of the bottom of the planter unit, but will allow suitable drainage of excess water. If desired, a grate and corresponding soil filter can be placed at the lower portion of each plant section of a planter unit 12. The vertical separation between plant sections allows one plant section to be filled with soil, and an underlying plant section to be free of interior soil. FIG. 5 illustrates the bottom of a planter section 100 according to another embodiment. The grate can be small openings or slots 102 of any shape formed in the bottom of the planter section 100.

Each planter section 12 is constructed so as to be stackable to provide a vertical array of planter units. The top of each planter unit 12 includes a rectangular-shaped female inlet 86. The bottom of each planter unit 12 includes a rectangular male outlet 88 in the form of a rectangular shell. The shape of the female inlet 86 of one planter unit 12 allows the male outlet 90 of the overlying planter unit 14 to snugly fit therein. The male outlet 88 of the bottom planter unit 12 is constructed to snugly fit into a rectangular opening 92 of the water reservoir 52. The nesting of the male and female connection between the vertical planter units 12 and 14 allows the vertical planter units to be stacked together to achieve vertical planter 10 of a desired height, and with water drainage from the upper planter units through the underlying planter units, to the water reservoir 52. In addition, the nesting of the male outlet into the female inlet provides registration between the vertical planter units and prevents dislodgment of one planter unit with respect to another planter unit. No hardware is required to fasten one planter unit to another planter unit. As will be described below, each planter unit is fastened to a wall to sustain the weight of the respective planter unit. Thus, the lower planter units do not have to withstand the weight of the overlying planter units.

As noted above, the vertical planter of the invention allows multiple planter units to be connected together in a side-by-side arrangement. When vertical planters 10 are arranged side-by-side, the water reservoir 52 should be constructed to accommodate such an arrangement so that the excess water drained from each of the bottom planter units drains into a common reservoir 52.

FIG. 4 illustrates the brackets for mounting the planter unit 12 to a vertical surface, such as a wall 16. Attached to the wall 16 is a J-shaped channel 96. Attached by screws, or the like, to an upper portion of the back surface of the planter unit 12 is an inverted J-shaped channel 98. The J-shaped channel 96 can be engaged together so that the planter unit 12 is supported by the channel 96 that is anchored to the wall 16. During installation of the vertical planter 10, the J-shaped channel 96 for each planter unit is fastened to the wall 16. The water reservoir 52 is then located against the wall 16. The inverted J-shaped channel 98 of the bottom-most planter unit 12 is hung on the J-shaped channel 96 anchored to the wall 16, so that the male water outlet 88 is snugly fit within the female inlet 92 of the water reservoir 52. The next planter unit 14 is similarly installed and hung on the wall 16 so that its lower male outlet 90 snugly fits within the female inlet 86 of the underlying planter unit 12. Other upper planter units can be similarly installed. The bracket channel 98 is removable from the back of the planter unit 12. If the user prefers to remove the bracket channel 98, the planter unit 12 can be screwed directly to a wall 16 or other vertical surface by inserting screws into the holes that would otherwise be used for the bracket channel 98 to the planter unit 12. The screw holes for each bracket channel 98 should be at the outer edges of each planter unit 12, and at the center of each planter unit 12, and should align with potential studs on a wall 16 where the planter units are to be mounted. When the planter units are attached to a brick, concrete or solid wood wall, the spacing of the screw holes is not critical. It should be noted that the shape of the bracket channels 96 and 98 can be other than J-shaped, such as V-shaped, square-shaped, or otherwise.

FIGS. 1 and 4 illustrate two planter units 12 and 14 attached to a wall 16, with a water capture basin or reservoir 52 located below the bottom planter unit 12. While the water capture basin 52 is shown to be somewhat wider than a planter unit, the basin 52 can be constructed with different widths to accommodate planter units arranged side by side on a wall. Since the excess water from each planter unit drains downward by gravity, the vertical planter 10 allows for placement of a water capture basin 52 below one or more planter units. A small quiet water pump 74 resides at the bottom of the capture basin 52 and pumps water from the capture basin 52 through the main water tubing 72 extending to each planter unit, via a series of connecting tubes 68, 70 etc. The capture basin 52 provides for the recycling of water to assure optimum water usage, it being realized that the only water lost is that which is used by the plants, or lost through evaporation from the wet soil through the openings 22 in the planter unit faceplates 18. The water dripping or running out of the lower planter unit 12 into the capture basin 52 results in a soothing sound that is pleasant and masks other sounds in the immediate area. It is well known that the sound of water running into a reservoir of water is pleasant and relaxing

The capture basin 52 can be periodically refreshed with water manual by using a container, or can be equipped with automatic filling apparatus connected to a source of water to restore the level of water in the capture basin 52 once a predetermined low level has been reached. In addition, water soluble fertilizers, chemicals or other additives can be placed in the capture basin 52 so that the plants in each planter unit are automatically treated during the watering cycle.

The water pump 74 can be operated with a timer (not shown) so that the plants are watered at specific times, and for specific time periods. Alternatively, the timer can be used to control a valve (not shown) that closes one outlet port and prevents water from flowing to the main water tubing 72 and thus to the plants in each of the planter units. When operated, a second outlet port of the valve opens and allows water to be pumped to a horizontal apertured tube overlying the capture basin 52. With this arrangement, the pump 74 continually pumps water in a recirculating manner from the capture basin 52 to the horizontal apertured tube just above the capture basin 52, and back into the capture basin 52. This produces a continuous sound of running or dripping water into the capture basin 52. When the timer is triggered, the pump 74 continues to run, but the valve then allows the water to be routed to the planter units. The main water supply tubing 72 can be equipped with manual-operated valves to control the amount of water directed to each section of plants. This allows some plants of a section with low water needs to receive less water than other plants in other sections of the planter unit that require more water.

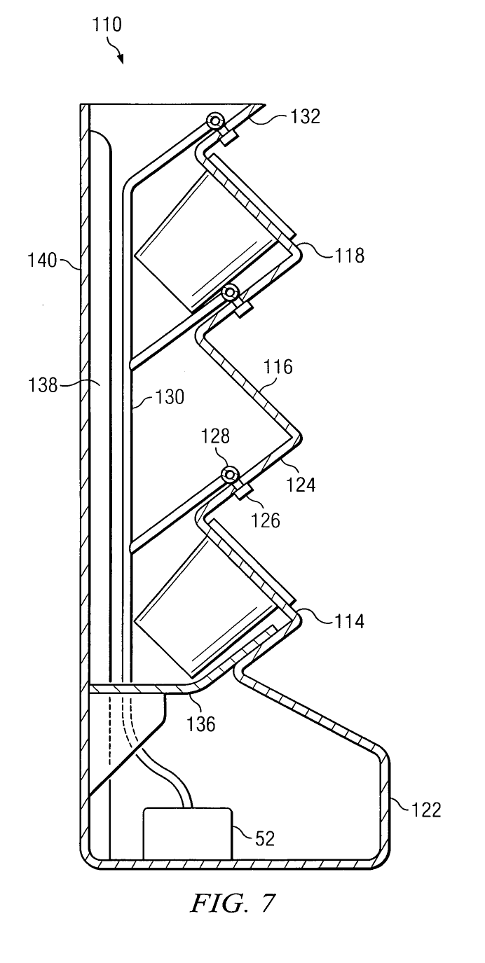

According to another embodiment of the invention illustrated in FIGS. 6 and 7, disclosed is a self-contained vertical planter 110. The vertical planter 110 can be made from a variety of structurally strong and water tight materials. The vertical planter 110 can be constructed with a plastic material, and formed as a single body component, except for the lid 112, using manufacturing techniques such as “rotational molding” or “blow molding.” Alternatively, the vertical planter 110 could be constructed from individual components that are bonded together to form a unitary unit. For example, the front, sides, top and bottom of the planter 110 can be molded as a single body component, and the back can be molded separately and then bonded to the body component to make the overall unit waterproof and sufficiently rigid to hold soil and plants therein without cracking or flexing. The faceplates are shown integral with the vertical planter 110, but can be made removable so that a unit can be fitted with different faceplates to receive different size plants therein. In this instance, the removable faceplate can be snap fit, screwed or otherwise fastened to the rectangular opening in the unit. Corrosion resistant metals and other synthetic materials can be used with equal effectiveness. The vertical planter 110 is 20 inches wide, 24 inches high and 9.5 inches deep, but can be constructed with a variety of other dimensions. Each unit in the preferred embodiment is constructed with three flat panels or faceplates 114, 116 and 118 for each section. Each faceplate is molded to accommodate four horizontal plant locations, one shown as numeral 120 for faceplate 114. Other numbers of plant locations in a faceplate 114 can be employed. Each of the faceplates 114, 116 and 118 is angled, like stair steps that are oriented vertically. However, the depth and height of the vertical planter 110 is variable to allow flexibility for installation. The vertical planter 110 widens at the bottom to form a water basin 122 below the stair-step sections. Vertical planters 110 could be made of different sizes (height, width, depth) with more of fewer angled planting panels or faceplates. The vertical planter 110 is designed to be freestanding on the water basin 122.

The plant openings 120 of each faceplate 114, 116 and 118 can be used as respective receptacles for pots. In FIG. 6, four-inch potted plants can be placed in the plant openings 120. The diameter of the plant openings 120 are formed so that the annular rim of a plastic pot will prevent the pot from falling through the plant opening 120. This feature allows a uses to select and arrange plants until a desired design is achieved. If a plant dies, then it is easy to remove the old plant and replace it with a new potted plant. Additionally, if one desires to change the color of the potted flowers periodically, then one needs only to remove the plants and replace them with plants having different colored foliage or flowers. This avoids working with the replacement of soil and the messy job of planting the new plants in the soil.

The vertical planter 110 can also be equipped with overhead emitters to water the potted plants externally. The emitters are typically called “barb emitters,” and are rated by flow rate in GPH or gallons per hour. The small amount of resistance or back pressure provided by the emitters assists the water to reach each emitter evenly. Without back pressure resistance, the water can flow from the lower emitters and fail to reach the emitters in the higher plant positions. Adequate results can be achieved with emitters having a flow rate of about 0.5 GPH to 2.0 GPH. Although most any flow rate can be used, best results are achieved with emitters that are not too restrictive in terms of back pressure, as this would require a larger pump.

The water emitters are illustrated in the cross-section of the vertical planter 110 of FIG. 7. A small hole is either formed or drilled into the vertical planter 110 on the flat angled surface area 124 above each pot location in each plant section. An emitter head 126 is then inserted and press fit into the hole, facing outward. Many emitters have an annular notch at the base of the emitter head. If the hole in the angled surface area 124 is sized properly, a snug fit can be achieved and the emitter 126 will be held in place. The four watering heads 126 associated with each of the four opening 120 of a faceplate 114 are connected directly to a respective horizontal flexible feed tubing, such as shown by numeral 128 and water head 126. One end of the bottom-most horizontal water feed tube is coupled to a vertical main water supply tube 130. The lower end of the vertical water supply tube 130 is connected to a pump 52 located in the bottom of the water basin 122. The other end of the bottom-most feed tube is connected to the next upper feed tube, and so on so that the three feed tubes are fed water in series. The top-most feed tube is capped at the downstream end. Alternatively, the three feed tubes can be fed by the main water supply feed line 130 in parallel. When the pump 52 is operating, the water in the basin 52 is pumped up the main supply tube 130 in series to each of the three horizontal feed tubes 128. From each of the horizontal feed tubes 128, the water is delivered under pressure to each of the four emitter heads 126 of a section. The water drips from each emitter 126 into the respective underlying pot to externally water the plants during the period of watering. The excess water from each pot drains through the pot drain holes back into the water basin 52. The water is recycled to optimize water usage, it being understood that most of the water is lost through plant use and evaporation.

The vertical planter 110 is adapted for filling with soil for planting plants therein. Since the vertical planter 110 can be filled with soil, plants can be planted directly in the soil through the plant holes 120 of the faceplate 114. With this method, the user can fill the section with soil or plant growing media, near the top of the plant openings. Plants can then be planted directly into the soil through the plant openings. The interior area of the vertical planter 110 can be filled with soil or other plant growing media. The media could be organic or any commercially viable type of potting mix, or simply a media designed to transport water that will allow osmosis. The soil or mix can be inserted into the vertical planter 110 either through the plant openings 120, or by removing the faceplate 114 and placing the soil in the interior of the unit. Plants are placed into the circular openings 120 of the vertical planter 110 with the upper part of the plant displayed outside the vertical planter 110, while the root portion resides inside the interior for receiving water and nutrients.

Although the interior of the vertical planter 110 can be open and without barriers or internal divisions, it can be compartmentalized for each plant by inserting a water permeable bag with a round opening into each plant opening 120, instead of a hard plastic pot. The same type of bag 36 can be utilized as shown and described in connection with FIG. 2. When configured to fill the interior of the vertical planter 110 with soil, the user can manually water the soil and thus the plants by removing the top cover 112 of the vertical planter 110 and pouring water into the open top to wet the soil. In this instance, the water heads 126 would not be used. Alternatively, a submersible pump 52 can be placed into the water basin 122. As yet another option, the pump 52 can be connected to an interior array of irrigation tubes that distribute the water to the soil that fills the interior of the vertical planter 110. Optimally, and as described above in connection with FIG. 7, the vertical water tube 130 connects to lateral tubes 12, with an emitter 126 located directly over each plant opening on the angled faceplate. This ensures more even drip watering of the plants in the vertical planter 110.

Each plant opening 120 in the faceplate can be about four inches in diameter and thus will accommodate four-inch pots. One can mix and match a number of different pots in a single unit, by using faceplates having different diameter openings. This is useful to accommodate different plants of slightly different sizes to provide an aesthetically pleasing arrangement of plants. For example, some plant locations can be decorative ferns or vines, and other plant locations can be populated with flowered plants. Other plants, including vegetables or herbs can be planted at each plant location.

This flexibility of having two different planting options is a feature of the vertical planter 110, because some plants need a large volume of soil to grow and maintain optimum health. Without sufficient soil volume, the plants can become root-bound, resulting in stifled growth or death. Other plants may be more suitable to containers like the plant pots or the bagged plants. Some sections of a vertical planter 110 can accommodate potted plants and other sections of the unit can be filled with soil and plants planted therein via the plant openings. This provides a great versatility in the different type of plants that can be used to make an overall arrangement.

The vertical planter 110 is constructed with an overhead watering fill opening 113 which allows for the vertical planter 110 to be watered manually, or a submersible pump 52 can be employed, or both. During molding of the vertical planter 110, the back side 140 is formed with two or more inwardly directed support ribs, one shown as numeral 138. The support ribs 138 provide rigidity to the back side of the vertical planter 110 so that it remains upright when populated with plants.

The water-carrying circuit of the self-contained vertical planter 110 includes a vertical water supply manifold 130 that extends from the pump 52 outlet upwardly on one side of the vertical planter 110. There are three lateral branches from the vertical water manifold 130 that carry water laterally to each emitter head location. From each lateral branch, there is a junction where a lateral is connected to the emitter head 126 for each of the four plant locations. One method of achieving uniform water delivery from each emitter head 126 is through the natural back pressure, or resistance, created by the emitter heads 126 themselves. The emitter heads 126 control the amount and type of water flow. Some emitter heads 126 will cause slow drips into the pots or soil media. Other emitter heads may spray a fine mist or fog onto the plants. The emitter heads generally have a water supply tube input side and a nozzle where the water is emitted. Another way to ensure proper watering of the plants is to add a valve at the junction to the tubing carrying water to the emitter heads in each plant row. Each valve can be adjusted to compensate for the differing pressures resulting from the gravitational effect of having rows of different plant heights. The valves are much like an adjustable water valve used in an aquarium. Each valve can be adjusted to provide the proper amount of water for each plant during the watering cycle. The emitter head 126 at each plant location is fastened within the overlying angled panel 124 by means of pushing the barb of the water head 126 into the hole until the barb latches inside the angled panel 124. Once the barb of the water head 126 pops into place, the water head 126 cannot be easily pulled back through the hole.

As described above in connection with the vertical planter 10 of FIG. 1, the angle of the faceplate 114 is important. The faceplate orientation of the vertical planter 110 is essentially the same as that of the vertical planter 10.

Each vertical planter 110 is equipped with two water access holes for the external input of water. One water access port 113 is formed in the top of the vertical planter 110, and when not in use is covered by a lid 112. The top opening 113 includes a flared part 132 to make it easy to pour water into the vertical planter 110 without spilling the water. To that end, the flared part 132 of the top of the vertical planter 110 functions as a funnel. The water then drains through the soil media from the top and eventually into the base 122. The other reason for the flared part 132 is that when the vertical planter 110 is configured for watering by the emitter heads 126, the flared part 132 provides a properly angled surface in which to mount the emitter heads so as to be located over the top row of plants in faceplate 118. The other inlet for pouring water into the vertical planter 110 is the opening 134 formed in the basin 122.

FIGS. 6 and 7 illustrate the water capture basin 122 below the bottom section. While the water capture basin 122 is shown to be somewhat greater in depth, the basin 122 can be constructed with different widths and or depths. Since the excess water from each section drains downwardly in the vertical planter 110, the water capture basin 122 is located below the plants. A small quiet water pump 122 can be placed at the bottom of the capture basin 52 to pump water through the system of water delivery tubes to the emitter heads 126. Again, the water dripping or running out of the lower section into the capture basin 122 results in a soothing sound that is pleasant and masks other sounds in the room or area.

The capture basin 122 can be periodically refreshed with water in a manual manner using a container, or can be equipped with automatic filling apparatus connected to a source of water to restore the level of water in the capture basin 122 once a predetermined low level has been reached. In addition, water soluble fertilizers, chemicals or other additives can be placed in the capture basin so that the plants in each section are automatically treated during the watering cycle. The pump 52 can be controlled in the same manner as described above in connection with the vertical planter 10 of FIG. 1.

In FIG. 7 there is illustrated a soil barrier and debris screen 136. The soil barrier 136 is constructed with a stiff screen with an open grid pattern. On top of the soil screen is placed a fabric or filter material. The combination of the rigid screen 136 for strength and the filter for its tighter weave provides a good barrier for keeping soil from falling into the water basin 122. The soil barrier 136 is removable and replaceable through the top opening 113.

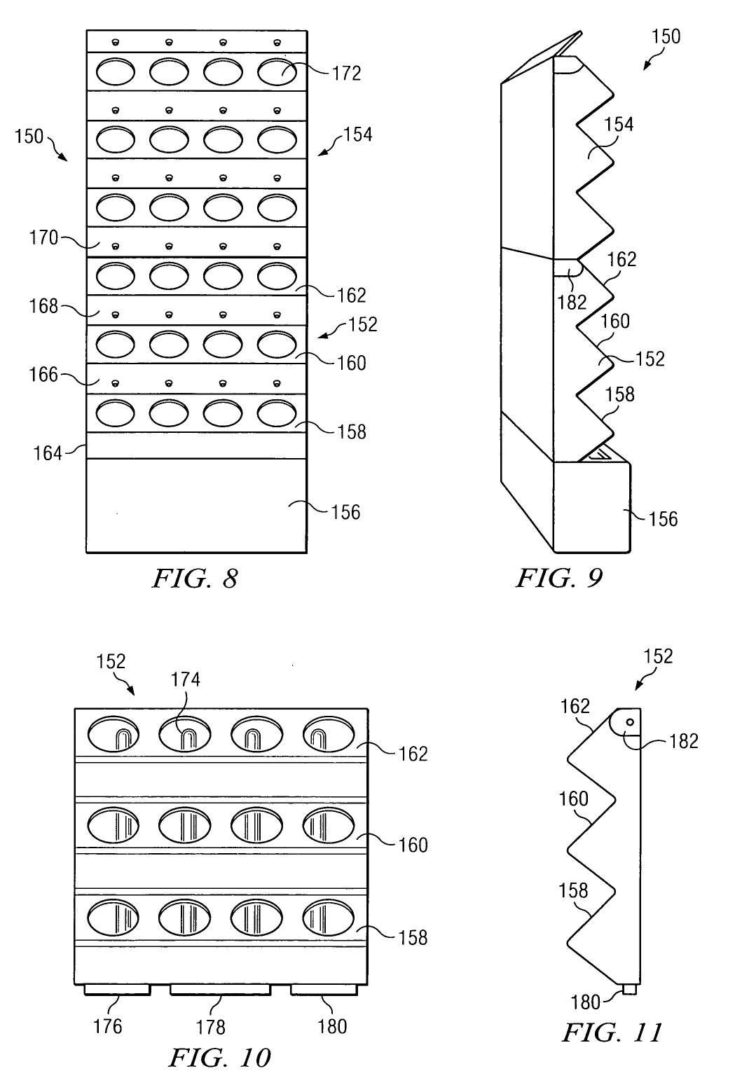

FIGS. 8-16 illustrate another embodiment of a vertical planter 150. FIGS. 8 and 9 illustrate a stacked array of two planter units 152 and 154. The planter unit 154 is stacked on top of planter unit 152. The lower-most planter unit 152 is stacked on a water reservoir or basin 156. Each planter unit is constructed in an identical manner. Planter unit 152, for example, includes a stair step frontal surface with three faceplates 158, 160 and 162, and three angled panels 164, 166 and 168. Angled panels 166 and 168 can be fitted with water heads for watering the potted plants in the underling faceplates 158 and 160. The plants planted in the openings of faceplate 162 of planter unit 152 are watered from the water heads mounted in the angled panel 170 of the overlying planter unit 154. To be described below, the plants planted in the openings in the top faceplate 172 of the upper planter unit 154 are watered by water heads mounted in a separate angled panel mounted to the top of the planter unit 154.

The details of the planter unit 152 are illustrated in FIGS. 10-13. The planter unit 152 is constructed by molding thereof using a moldable plastic material. The frontal surface of the planter unit 152 is shaped much like those described above. The back surface of the planter unit 152 is strengthened using vertical support ribs, one shown as numeral 174. Formed in the bottom of the planter unit 152 are three drain outlets 176, 178 and 180. The irrigation water that drains back into the planter unit 152 from the potted plants collects in the bottom of the planter unit 152 and drains out through one or more of the drain outlets 176, 178 or 180 to either the underlying planter unit or the underlying water basin 156. Formed in the upper part of the planter unit 152 on opposite sides are recessed indentions, one shown as numeral 182, which will be described below.

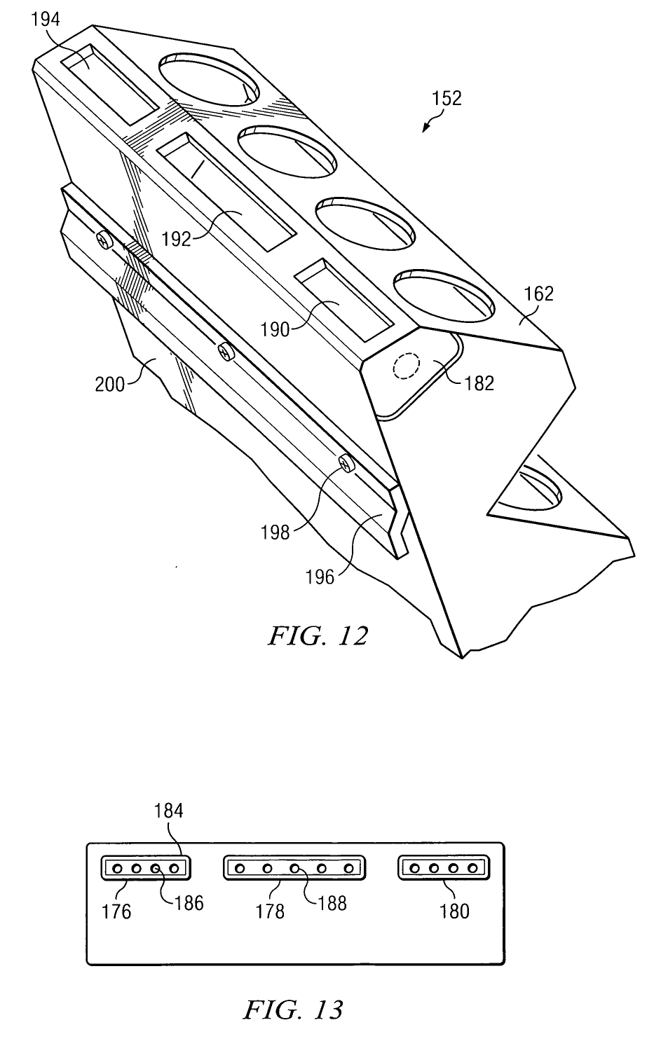

The three drain outlets are shown in the bottom view of FIG. 13. The outlet drain ports 176, 178 and 180 are constructed with respective extended shell portions, one shell extension shown as numeral 184 for outlet drain 176. Each drain outlet 176 has formed therein plural drain holes, one shown as numeral 186. A filter material can be placed over the drain holes 186 to prevent soil and particulate matter from draining back into the water basin 156. The center drain outlet 178 includes an additional hole 188 for allowing a water supply line to be extended therethrough from the pump 74 to the overlying planter units 152 and 154, as well as to any side-by-side planter units.

The top drain inlets of the planter unit 152 are illustrated in FIG. 12. Here, the top of the planter unit 152 includes three cutouts 190, 192 and 194. The three coutouts 190, 192 and 194 are shaped in a similar manner as the bottom outlet ports 176, 178 and 180 so that the outlet ports of an upper planter unit 154 can snugly fit into the corresponding drain inlets of the underlying planter unit 152. The planter unit 152 of FIG. 12 also illustrates a Z-bracket channel 196 that is fastened to the back surface 200 with screws 198. An inverted Z-bracket channel is fastened to a wall 16 so that the planter unit Z-bracket channel 196 can be lowered into the wall channel bracket. In this manner, the weight of the planter unit 152 can be supported by the wall 16. One or more Z-bracket channels 196 can be mounted to the back 200 of the planter unit 152.

The indented area 182 formed in, the top of the planter unit 152 is to accommodate the extension of a lateral water distribution tube into the planter unit 152, and if needed to an adjacent planter unit. A marine seal is employed to seal the lateral water distribution tube in one or both sides of the planter unit 152. The indented area 182 accommodates the width of the marine seal so that the side surfaces of adjacent planter units contact each other when placed side by side.

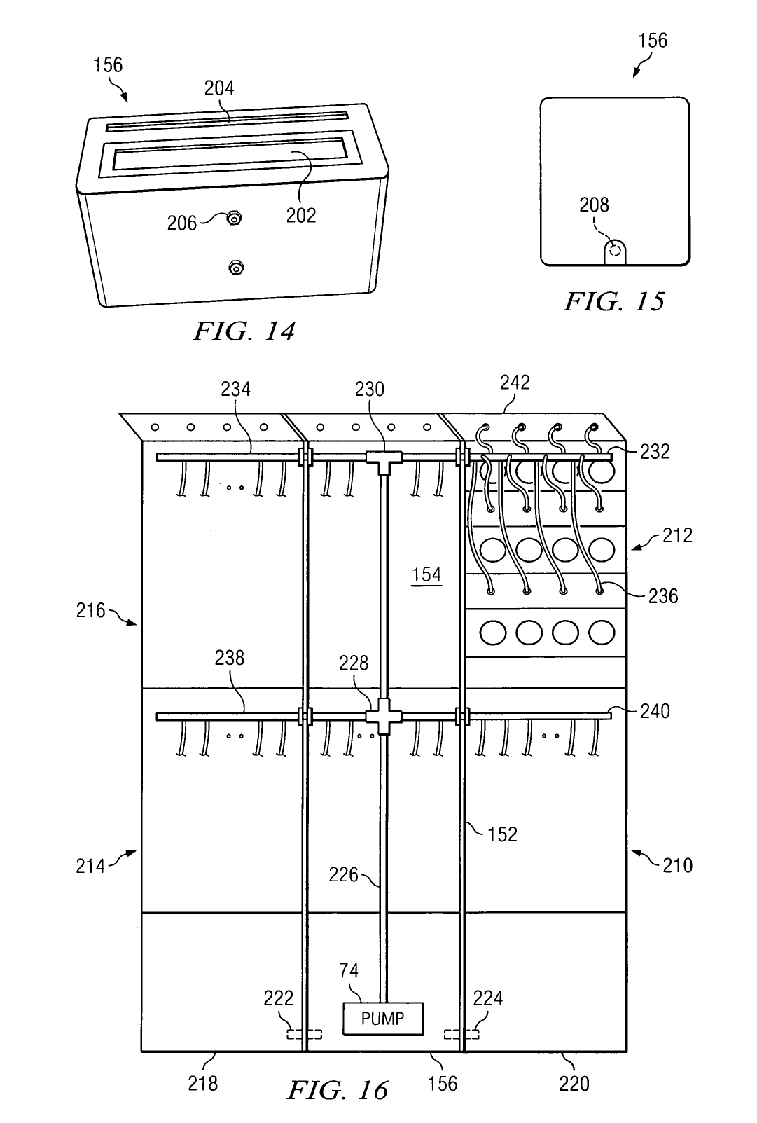

FIGS. 14 and 15 illustrate the details of the water basin 156. Much like the planter units 152 and 154, the water basin 156 is constructed by molding a plastic material. The top of the water basin 156 includes a large water inlet 202 for pouring water into the water basin 156. A drain inlet 204 is formed in the top of the water basin 156 for receiving therein the outlet drain ports 176, 178 and 180 of the overlying planter unit 152. Auxiliary metal threaded members can be embedded in the plastic of the various components of the vertical planter 150. One metal threaded member is shown as numeral 206. Formed on each side at the bottom of the water basin 156 is an indented area 208. Again, this is to accommodate the thickness of a marine washer when fluid coupling one water basin to an adjacent water basin.

FIG. 16 illustrates the water distribution system for use when an array of planter units are both stacked together and placed side by side. In the example, the planter units 152 and 154 are shown as the middle stacked planter units. Stacked planter units 210 and 212 are placed on the right side of the middle planter units 152 and 154. Stacked planter units 214 and 216 are placed on the left side of the middle planter units 152 and 154. Situated under each of the stacked planter units is a respective water basin 156, 218 and 220.

Preferably, a single water pump 74 is utilized to provide pressurized water to each of the planter units, for watering either the soil placed therein, or potted plants via water heads. The pump 74 is shown located in the middle water basin 156. In order that the drain water collected in the two other water basins 218 and 220 can flow to the pump 74 in the middle water basin 156, all of the water basins are fluid coupled together. This is accomplished by drilling a hole in the indented areas at the bottom of both sides of the middle water basin 156, and in one indented area of the other water basins 218 and 220. A short drain tube 222 is extended between the water basins 156 and 218, and sealed in both water basins 156 and 218 by conventional marine washers. A short drain tube 224 places the water basins 156 and 220 in fluid communication in a similar manner. Thus, any water that collects in the water basins 218 and 220 can flow into the middle water basin 156 and be pumped by the pump 74.

The pump 74 pumps irrigation water upwardly through the water supply tubing 226 to the overlying planter unit 152, to a connection 228, and therefrom to the top planter unit 154 to a T-connection 230. From the T-connection 230, a lateral tube 232 couples water to the right hand top planter unit 212, and via a lateral tube 234 to the left hand top planter unit 216. As shown in the top right planter unit 212, flexible water tubes 236 are coupled from the lateral tube 232 to the various water heads mounted in the angled panels. The couplings of the flexible tubes 236 to the lateral tube 232 can be carried out conventionally by punching a hole in the lateral tube 232 and press fitting a connection therein for connecting to the end of the flexible tubing 236. Flexible tubes are connected to the lateral tube 234 in a similar manner to provide a source of pressurized water to the water heads of the planter unit 216. Lastly, flexible tubes are connected to both lateral tubes 232 and 234 for watering the plants in the middle planter section 154. As an alternative, only the top lateral tubes 232 and 243 can be utilized, and flexible water tubes can be connected thereto to distribute water to all of the planter units. When the planter unit houses plants grown in soil inside the planter unit, then the lateral tube 232 can be perforated to allow water to drip on the surface of the soil interior to the planter unit.

The lower planter sections are coupled to the lateral tubes 238 and 240 that are connected to the connection 228. Flexible tubes are connected to one or both of the lateral tubes 238 and 240 and extended to the water heads of the twelve angled panels of planter units 152, 214 and 210. The lateral tubes 232, 234, 238 and 240 extend through the sides of the planter units via the indented areas which are drilled out so that the lateral tubes can be extended therethrough. The lateral tubes are sealed to the holes in the indented areas with marine seals in the same manner described in connection with the water basins.

The top-most plant positions can be watered via water heads mounted in auxiliary angled panels 242. The angled panels 242 can be fastened to the top back surface of each planter unit 154, 216 and 212 so that the angled part of the panels overlie the top openings in the top plant sections.

The use of a single pump 74 is cost effective to supply pressurized water to an array of planter units. The uniform distribution of pressurized water to all of the upper planter units and the lower planter units can be facilitated by using lower GPH water heads in the lower planter units, intermediate GPH water heads in the intermediate planter units, and higher GPH water heads in the upper planter units. For example, 0.5 GPH water heads can be used in the lower planter units, 1.0 GPH water heads can be used in the intermediate planter units, and 2.0 GPH water heads can be used in the upper planter units. This use of water heads providing different flow rates of water can make the distribution of pressurized water more uniform, irrespective of the elevation of the planter unit in the array.

The various features of each embodiment can be readily employed in the other embodiments of the invention. For example, when practical, feasible or apparent, the various features of the vertical planter 10 can be employed in the vertical planter 110, and vice versa.

While the preferred and other embodiments of the invention have been disclosed with reference to a specific vertical planters, and associated methods of construction and use thereof, it is to be understood that many changes in detail may be made as a matter of engineering choices without departing from the spirit and scope of the invention, as defined by the appended claims.

What is claimed is:

1. A vertical planter for growing vegetation, comprising;
a planter unit comprising plural plant sections where each plant section has plural locations, each location for growing a plant;
said plant sections arranged in a vertical manner to form a unitary said planter unit;
each said plant section having a faceplate with openings therein for holding a plant, and each faceplate angled to hold the plants at an angle;
each plant section of the unitary planter unit having an interior in common with other plant sections of the planter unit so that water that drains from the plants flows through the underlying plant sections to a bottom of the planter unit; and
a water reservoir underlying a lower-most plant section so that water drains from the planter unit into the reservoir.

2. The vertical planter of claim 1, further including a water distribution system contained within said planter unit, and including a water pump located in said water reservoir, said water distribution system including water tubing coupled from said pump to each plant location of each said plant section.

3. The vertical planter of claim 2, further including a water head fixed to each said plant section for dispensing water downwardly outside said planter unit onto respective underlying plants located in the plant sections.

4. The vertical planter of claim 2, further including an apertured water distribution tubing coupled to said pump, said water distribution tubing located inside said planter unit for dispensing water internal to said planter unit onto roots of the plants.

5. The vertical planter of claim 1, wherein a frontal surface of said planter unit is stair step shaped.

6. The vertical planter of claim 1, further including a plurality of said planter units, each said planter unit having a top opening and a bottom opening, where a bottom opening of one planter unit is coupled to a top opening of an underlying planter unit so that water can drain from said one planter unit through the underlying planter unit.

7. The vertical planter of claim 6, wherein said planter units are stackable together with an internal path for drainage of water from tip planter units to bottom-most planter units.

8. The vertical planter of claim 7, wherein said bottom-most planter unit has a bottom opening coupled to the water reservoir.

9. The vertical planter of claim 8, further including a closed circuit water path form a pump located in said water reservoir upwardly to the plants, and from the plants back to the water reservoir.

10. The vertical planter of claim 8, wherein the bottom opening of the bottom-most planter includes a vertical shell that fits down into the opening of the water reservoir.

11. The vertical planter of claim 6, further including one or more hangers fastened to a back of each said planter unit, and further including a mating hanger adapted for fastening to a wall, wherein the fasteners fastened to the back of said planter units engage with the wall fasteners so that each said planter unit is supported by the wall and lower planter units do not have to support the weight of overlying planter units.

12. The vertical planter of claim 11, wherein the fasteners fastened to the back of the planter units are lowered into the wall fasteners, whereby the planter units are removable from the wall by lifting up the planter units and disengaging the planter unit fasteners from the wall fasteners.

13. The vertical planter of claim 1, further including a grate located at a bottom of the planter unit for preventing soil from exiting the planter unit through a bottom opening in the planter unit.

14. The vertical planter of claim 13, further including a grate below each said plant section in said planter unit.

15. The vertical planter of claim 1, further including a mesh bag for holding soil therein, said mesh bag adapted for insertion into an opening in said faceplate, and said mesh bag adapted for holding a plant planted in the soil.

16. The vertical planter of claim 15, wherein said mesh bag includes a rigid support ring larger than a diameter of the plant opening.

17. The vertical planter of claim 1, wherein said planter unit further includes a top opening into which water can be poured into the interior of the planter unit, and further including a removable lid for covering the top opening.

18. The vertical planter of claim 17, further including an opening in the water reservoir through which water can be poured into the water reservoir, whereby the planter unit includes two openings into which water can be poured into the vertical planter

19. The vertical planter of claim 1, wherein said faceplates are removably fastened to the planter unit so that faceplates having first size openings can be replaced with a second faceplate having different size openings.

20. A vertical planter for growing vegetation, comprising;
a base comprising a water reservoir for resting on a flat surface, said base having an opening therein for pouring water into the reservoir;
plural plant sections formed as a unitary unit together with said water reservoir, said plant sections having a frontal surface that is stair step shaped, parallel first surfaces of the stair step frontal surface having openings therein for holding potted plants therein, and parallel second surfaces of the stair step frontal surface having water heads mounted therein, each said water head located over a respective plant opening;
a top of the unitary unit including an opening through which water can be poured;
a lid for covering the top opening of the unitary unit, said lid being removable from the top opening;
a water tubing system mounted inside said unitary unit and connected to each said water head; and
a pump connected to the water tubing system, said pump located in said water reservoir for pumping water through the water tubing system through the water heads and onto plants located in the plant sections.
